(19) United States
(12) Patent Application Publication
(10) Pub. No.: US 2017/0323397 A1
(43) Pub. Date: Nov. 9, 2017

(54) PUBLISHER FOR GENERATING A PROFILE TIMELINE

(71) Applicant: Linkedln Corporation, Mountain View, CA (US)

(72) Inventors: Divyakumar Menghani, Sunnyvale, CA (US); Matthew Spencer Rendely, San Francisco, CA (US); Vibhu Prakash Saxena, Milpitas, CA (US)

(21) Appl. No.: 15/145,513

(22) Filed: May 3, 2016

(51) Int. Cl. G06Q 50/00; G06F 17/30

(52) U.S. Cl. CPC G06Q 50/01; G06F 17/30551; G06F 17/30867

(57) ABSTRACT

Techniques for publishing a profile timeline of a member are described.. publisher receives, from a device of a viewer, a request to view a profile page of a member of an online social network. The publisher accesses employment data of the member having a first job associated with a first job title at a first employer with a specific duration. Additionally, the publisher can select a plurality of other members, each member in the plurality of other members having a similar job title related to the first job title. Furthermore, the publisher can determine an average duration for the first job title based on information accessed from the plurality of other members, and generate a first timeframe using the accessed employment data of the member. Subsequently, the publisher causes a presentation, on a display of the device, of the profile page of the member having the generated first timeframe.

### TECHNICAL FIELD

The subject matter disclosed herein relates generally to the technical field of data processing and specifically to processing member data to generate a profile timeline.

### BACKGROUND

An online social networking service can maintain information on members, companies, organizations, employees, and employers. The online social network may maintain profile pages of members, which can include education information and employment information about a specific member. The educational information and employment information can be listed in a resume-format in the profile page that can be viewed by scrolling the profile page to view all of the information. In some instances, relevant employment and educational information may not be easily conveyed on the profiles pages of the members.

### BRIEF DESCRIPTION OF THE DRAWINGS

Some embodiments are illustrated by way of example and not limitation in the figures of the accompanying drawings.

FIG. 1 is a network diagram illustrating a network environment suitable for an online social network, according to some example embodiments.

FIG. 2 is a block diagram illustrating various components of an online social network, according to some example embodiments.

FIG. 3 is a flowchart illustrating a method for generating the profile timeline, according to some example embodiments.

FIG. 4 is a flowchart illustrating a method for calculating an average duration for a profile timeframe, according to some example embodiments.

FIG. 5 is a user interface diagram illustrating a profile page with a profile timeline, according to some embodiments.

FIG. 6 is a user interface diagram illustrating a profile timeline with employment and educational timeframes, according to some embodiments.

FIG. 7 is a block diagram illustrating components of a machine, according to some example embodiments, able to read instructions from a machine-readable medium and perform any one or more of the methodologies discussed herein.

### DETAILED DESCRIPTION

The description that follows includes systems, methods, techniques, instruction sequences, and computing machine program products that embody illustrative embodiments. In the following description, for the purposes of explanation, numerous specific details are set forth in order to provide an understanding of various embodiments of the subject matter discussed herein. It will be evident, however, to those skilled in the art, that embodiments of the inventive subject matter may be practiced without these specific details. In general, well-known instruction instances, protocols, structures, and techniques are not necessarily shown in detail.

Examples merely demonstrate possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident, to one skilled in the art, however, that the present subject matter may be practiced without these specific details.

According to some embodiments, a profile timeline of a member presents a summary of the educational and employment history of the member in one compact visualization. The profile timeline assists a viewer of the profile page by conveying chronological information about the member, such as the career progress of the member. For example, the profile timeline includes a chronology of the employment history of the member, such as the first employer being presented in a first timeframe, the second employer being presented in a second timeframe, and so on. Additionally, the profile timeline can include a third timeframe associated with an obtained college degree. The profile timeline presents a visual representation of the member's career and educational trajectory in order to allow the viewer of the profile page to easily understand the member's history. As a result, the profile timeline can provide a better experience to a viewer (e.g., recruiter, hiring manager, another member) by illustrating a complete overview (e.g., including gaps in the employment history) of the member's employment history and educational history.

In current implementations, a viewer may have difficulties determining relevant employment and educational information from a profile page. For example, the viewer may have to scroll up and down the profile page to gather all of the relevant information, and do some analysis to determine the member's employment and educational trajectory (e.g., gaps in the employment history). In contrast, according to some embodiments, the profile timeline conveys visually the relevant employment and educational information in one graph in order to allow the user to easily understand the member's employment and educational trajectory. The profile timeline can be generated based on different machine learning techniques or user-settings.

The profile timeline is generated based on relevant employment information and educational information. For example, the relevant employment information includes the total number of years of work experience, gaps in employment history, job titles, job descriptions, and employee tenure summary. An example of the employee tenure summary is the profile timeline highlighting the employer in which the member had the longest tenure. The relevant educational information includes school name, years of attendance, completion date, degree obtained, majors, and minors.

In some instances, when the viewer selects a timeframe (e.g., first timeframe, second timeframe), the profile timeline highlights the recommendations received by the member during the member's employment during the selected timeframe. For example, the viewer can select the first timeframe by clicking or hovering over the first timeframe with a mouse pointer.

According to some embodiments, the different employers are represented by using a first timeframe for a first employer, a second timeframe for a second employer, and so on. Alternatively, the first timeframe can be for the first job title at the first employer, and the second timeframe can be for the second job title (e.g., when the member is promoted) at the first employer. Moreover, the profile timeline can highlight when the member has switched industries or domains, and other relevant employment information (e.g., which industry the member has the most experience in).

Additionally, the profile timeline can convey visually the educational information of the member. The educational information includes the start date and end date of the different degrees (e.g., high school degree, undergraduate degree, graduate degree, professional degree) attained or currently in progress by the member.

According to some embodiments, the profile timeline presents a simple timeline of all the significant milestones using the profile information of the member. In some instance, the profile timeline includes information accessed from third-party websites, such as the employer website. The profile timeline summarizes and highlights the major career milestones of the member in a concise format.

Moreover, the profile timeline enables the viewer to interact with the timeline. For example, when a particular timeframe (e.g., first timeframe) is selected, relevant information about the particular timeframe is shown. The relevant information includes role description, project description, recommendations, and so on. In some instances, by clicking on a particular position or particular timeframe in the profile timeline, the browser is moved to that position in the profile page to allow the viewer to learn more about that position in detail.

Furthermore, a user interface can allow members to customize the profile timeline by selecting customizable user-settings. The user-settings can include factors related to the employment information or educational information, such as time factors, job titles, recommendations, and so on. For example, the user-settings can be set so that the profile timeline only includes employment information for a predetermined time interval (e.g., the past ten years).

According to some embodiments, a job statistics calculator can access member data of other members and calculate statistics for the first timeframe, the second timeframe, and so on. For example, the job statistics calculator can determine that an analyst at an investment-banking firm stays at that position for an average of two years. Therefore, when the first timeframe is associated with an analyst position at an investment-banking firm, the first timeframe is compared with the average duration. For example, the first timeframe is a first color when the specific duration is less than the average duration, and the first timeframe is a second color when the specific duration is more than the average duration.

Techniques described herein allow for a publisher to generate a profile timeline based on the relevant employment and educational information of the member. Additionally, the publisher can access member information of other similar members to determine statistics (e.g., average duration at a specific job title) for a specific timeframe in the profile timeline. The publisher can generate the profile timeline in real-time based on the plurality of databases storing the employment and educational information of members. In some instances, some of the processing to generate the profile timeline can be performed offline.

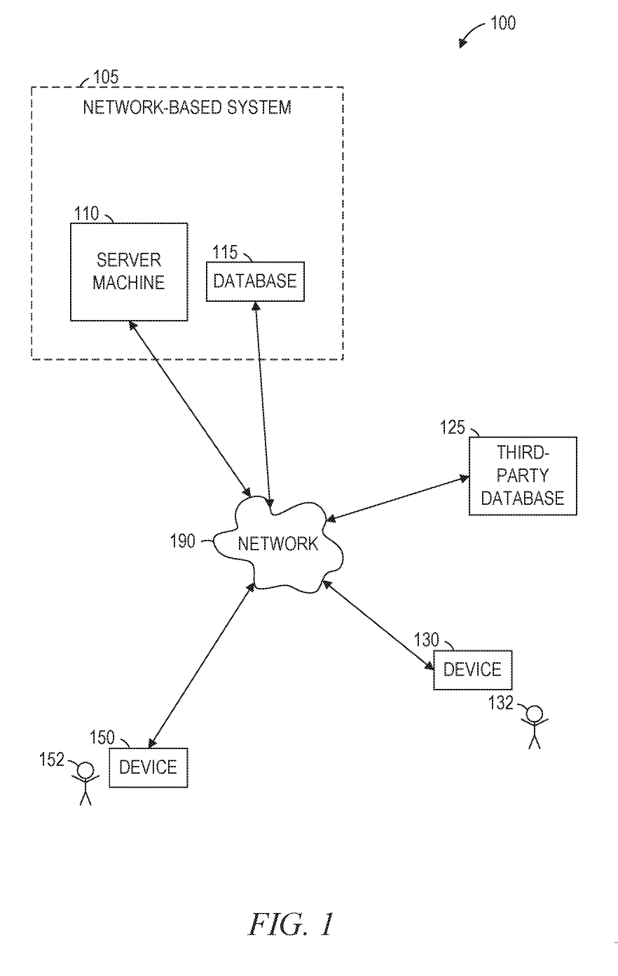

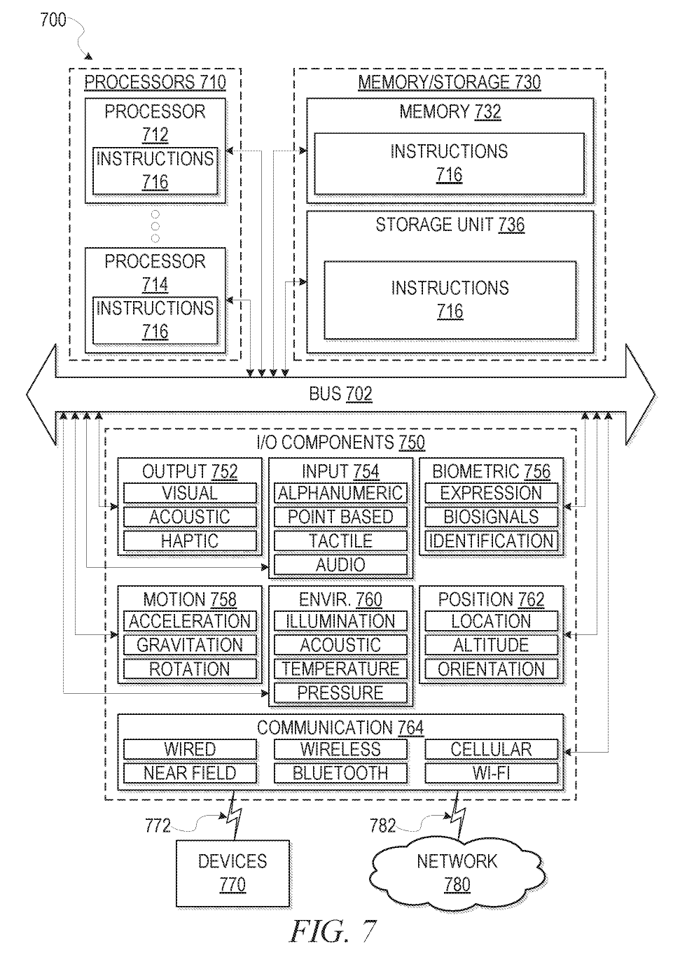

FIG. 1 is a network diagram illustrating a network environment 100 suitable for an online social network service, according to some example embodiments. The network environment 100 includes a server machine 110, a database 115, a third-party database 125, a first device 130 for a first user 132, and a second device 150 for a second user 152, all communicatively coupled to each other via a network 190. The server machine 110 and the database 115 may form all or part of a network-based system 105 (e.g., a cloud-based server system configured to provide one or more services to the devices 130 and 150). The database 115 can store, but is not limited to storing, member data, company data, education data, social graph data, and member activity data for the online social network service. In some instances, the database 115 can include a plurality of databases (e.g., a first database to store profile data, a second database to store social data, a third database to store member activity data). The server machine 110, the first device 130, and the second device 150 may each be implemented in a computer system, in whole or in part, as described below with respect to FIG. 7.

The third-party database 125 includes databases associated with employers, jobs, and so on. For example, the third-party database 125 can be the company websites that have profiles of the company's employers. The third-party database 125 can be accessed from other online social networks using publically available information. The server machine 110 can access the information in the third-party database 125 using the network 190.

Also shown in FIG. 1 are the users 132 and 152. One or both of the users 132 and 152 may be a human user (e.g., member of the online social network), a machine user (e.g., a computer configured by a software program to interact with the device 130 or 150), or any suitable combination thereof (e.g., a human assisted by a machine or a machine supervised by a human). The user 132 is not part of the network environment 100, but is associated with the device 130 and may be a user of the device 130. For example, the device 130 may be a desktop computer, a vehicle computer, a tablet computer, a navigational device, a portable media device, a smartphone, or a wearable device (e.g., a smart watch or smart glasses) belonging to the user 132. Likewise, the user 152 is not part of the network environment 100, but is associated with the device 150. As an example, the device 150 may be a desktop computer, a vehicle computer, a tablet computer, a navigational device, a portable media device, a smartphone, or a wearable device (e.g., a smart watch or smart glasses) belonging to the user 151

In some instances, the user 152 can be a member having a profile page on the online social network. Additionally, the user 132 can be a viewer requesting to view the profile page of the member. For example, the server machine 110 can receive, using network 190, a request from device 130 to view the profile page of user 152. The viewer can be a first-degree connection of the member. In some instances, when the viewer is not a first-degree connection of the member, the profile timeline is generated based on a publically available information on the profile page of the member. Therefore, when the viewer has limited access, the profile timeline is generated based on the information available with the limited access.

The network 190 may be any network that enables communication between or among machines, databases 115, and devices (e.g., the server machine 110 and the device 130). Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof. Accordingly, the network 190 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., a Wi-Fi network or WiMAX network), or any suitable combination thereof. Any one or more portions of the network 190 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

Any of the machines, databases 115, or devices 130, 150 described herein may be implemented in a computer modified (e.g., configured or programmed) by software (e.g., one or more software modules) to be a special-purpose computer to perform one or more of the functions described herein for that machine, database 115, or device 130, 150. For example, a computer system able to implement any one or more of the methodologies described herein is discussed below with respect to FIG. 7. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases 115, or devices 130, 150 described herein may be combined into a single machine, database 115, or device 130, 150, and the functions described herein for any single machine, database 115, or device 130, 15( )may be subdivided among multiple machines, databases 115, or devices 130, 150.

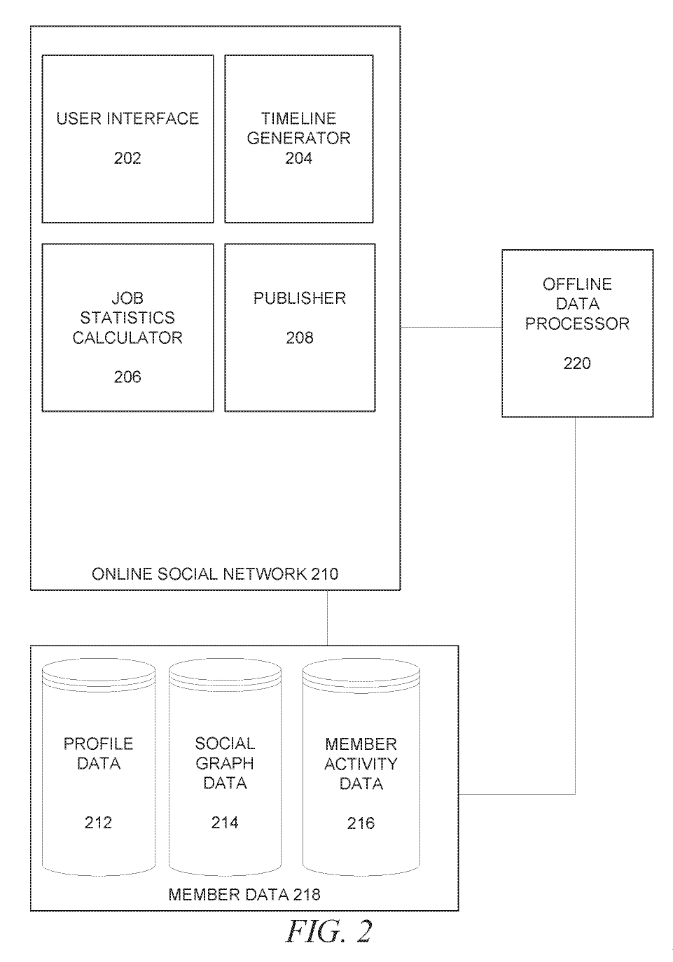

FIG. 2 is a block diagram illustrating components of an online social network 210, according to some example embodiments. The online social network 210 is an example of a network-based system 105 of FIG. 1. The online social network 210 can include a user interface 202, a timeline generator 204, a job statistics calculator 206, a publisher 208, all configured to communicate with each other (e.g., via a bus, shared memory, or a switch). The user interface 202 can provide information or cause an interface to be rendered on a client device of the member.

Additionally, the online social network 210 can communicate with the database 115 of FIG. 1, such as a database storing member data 218. Furthermore, the online social network 210 can communicate with the third-party database 125 of FIG. 1 via network 190.

The member data 218 can include profile data 212. Moreover, the member data 218 can include social graph data 214 and member activity data 216. Using the member data 218, the timeline generator 204 generates the profile timeline. In some instances, some of the processing of the data for generating the profile timeline can be performed by an offline data processor 220 on a periodic basis (e.g., nightly) in order to return results faster.

The profile data 212 include information available in a member's profile page, such as a member's personal and employment information. For instance, with many online social network services, when a user 132, 152 registers to become a member, the member is prompted to provide a variety of personal and employment information that may be displayed in a member's profile page. Such information is commonly referred to as profile data 212. The profile data 212 that is commonly requested and displayed as part of a member's profile includes the member's age, birthdate, gender, interests, contact information, residential address, home town and/or state, spouse's and/or family members' names, educational background (e.g., schools, majors, matriculation and/or graduation dates, etc.), employment history, job title, job industry, office location, skills, professional organizations, and so on. In some embodiments, the profile data 212 may include the various skills that each member has indicated he or she possesses. Additionally, the profile data 212 may include skills of a member that have been endorsed by another member.

With certain online social network services, such as professional network services, the profile data 212 can include employment information commonly included in a professional resume or curriculum vitae. The employment information can include a person's credentials (e.g., education), the company at which a person is employed, the location of the employer, an industry in which a person is employed, a job title or function, an employment history, skills possessed by a person, professional organizations of which a person is a member, a start date for a job, an end date for a job, and so on. In some instances, the member can upload documents, photos, links, videos, or presentations associated with a job. The profile data 212 includes the upload documents, photos, links, videos, and presentations.

Additionally, the online social network 210 may provide its users 132, 152 with a mechanism for defining their relationships with other people. This digital representation of real-world relationships is frequently referred to as a social graph, which may be stored in the social graph data 214. The social graph data 214 of a member can include first-degree connections, second-degree connections, and so on,

In some instances, the social graph data 214 can be based on an entity's presence within the online social network service. For example, consistent with some embodiments, a social graph is implemented with a specialized graph data structure in which various entities (e.g., people, companies, schools, government institutions, non-profits, and other organizations) are represented as nodes connected by edges, where the edges have different types representing the various associations or relationships between the different entities.

In addition to hosting a vast amount of social graph data 214, the online social network 210 maintains member activity data 216. Typically, a user input is captured when a user 132, 152 interacts with a particular graphical user interface element, such as a button, which is generally presented in connection with the particular entity or object and frequently labelled in some meaningful way (e.g., “like,” “±1,” “follow”). The user interaction with the online social network 210 can be captured and stored as member activity data 216. The member activity data 216 includes members' interaction with the various applications, services, and content made available via the online social network 210, and the members' behavior (e.g., content viewed, links selected).

Furthermore, the online social network 210 can be configured to process data offline or periodically using the offline data processor 220. In some instances, some or all of the calculations by the job statistics calculator 206 can be performed by the offline data processor 220. For example, the offline data processor 220 can include Hadoop servers that access the profile data 212 periodically (e.g., on a nightly basis) to calculate an average duration for a specific job title in an industry.

Moreover, some or all of the processing for generating the profile timeline can take place offline to ensure reliable performance of the online social network 210. For example, the timeframe generation for each job title or the profile timeline generation may be processed in the background or offline.

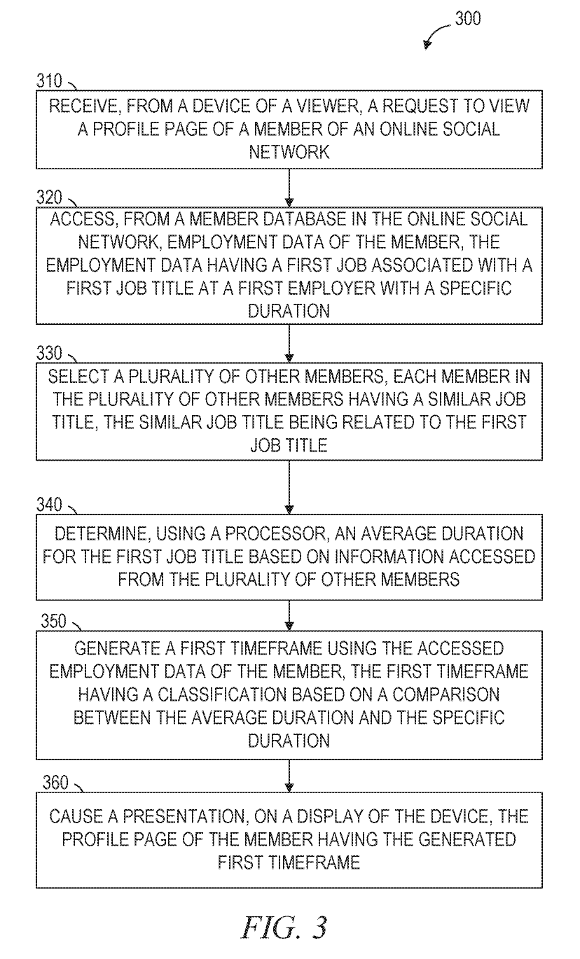

As will be further described with respect to FIGS. 3-6, the user interface 202, the timeline generator 204, the job statistics calculator 206, and the publisher 208 can publish a profile timeline based on the educational and employment information of the member.

FIG. 3 is a flowchart illustrating operations of the network-based system. 105 in performing a method 300 for publishing a profile timeline on the online social network 210, according to some example embodiments. Operations in the method 300 may be performed by the online social network 210, using the user interface 202, the timeline generator 204, the job statistics calculator 206, and the publisher 208 as described above with respect to FIG. 2. As shown in FIG. 3, the method 300 includes operations 310, 320, 330, 340, 350, and 360.

At operation 310, the timeline generator 204 receives a request to view a profile page of a member of the online social network 210. The request is received from a device of a viewer. For example, the viewer can be user 132 and the member can be user 152 of FIG. 1. Continuing with this example, the user 132, using device 130, can transmit a request to the network-based system 105, using network 190, to view the profile page of user 152. Additionally, the request can be transmitted and received using communication components (e.g., communication components 764 of FIG. 7).

At operation 320, the timeline generator 204 accesses, from a member database in the online social network 210, employment data of the member. The member database is similar to the database that stores member data 218. In some instances, the member database is the database 115 of FIG. 1. As previously mentioned, the profile data 212, which is part of the member data 218, includes employment data. The employment data includes a first job associated with a first job title at a first employer with a specific duration (e.g., start date, end date). In some instances, the specific duration is determined from a start date and an end date of the first job. For example, the start date and the end date can be listed on the profile page of the member. Additionally, the employment data can include a second job associated with a second job title at the first employer. Moreover, the employment data can include another job associated with another job title at a second employer.

In some instances, educational data of the member is also accessed at operation 320. As previously mentioned, the educational data includes a name of a school, a degree obtain, a start date, a completion date, and so on,

At operation 330, the job statistics calculator 206 selects a plurality of other members, each member in the plurality of other members having a similar job title. The plurality of other members are members that have a profile page on the online social network 210. In some instances, the plurality of other members only include the first-degree connections of the member.

The similar job title is related to the first job title. In some instances, the similar job title can have the same title as the first job title accessed at operation 320. For example, both the similar job title and the first job title can be “software developer.” Alternatively, the similar job title can be related to the first job title based on industry, salary, educational level, and so on. For example, the first job title can be an “associate” at a law firm, which is related to the similar job title of “attorney.”

Continuing with operation 330, the job statistics calculator 206 selects other members that have the same job title or a similar (e.g., related) job title as the first job title. Using standardization techniques and machine learning techniques, the job statistics calculator 206 determines the similar job titles, which, as described in the example above, can be different job titles for the same job or job functions.

According to some embodiments, the method 300 further includes the job statistics calculator 206 accessing, from a standardized jobs database, a list of job titles that correspond to the first job title. For example, the similar job title is related to the first job title when the similar job title is included in the list of job titles. Additionally, the similar job is related to the first job title when the similar job title matches the first job title.

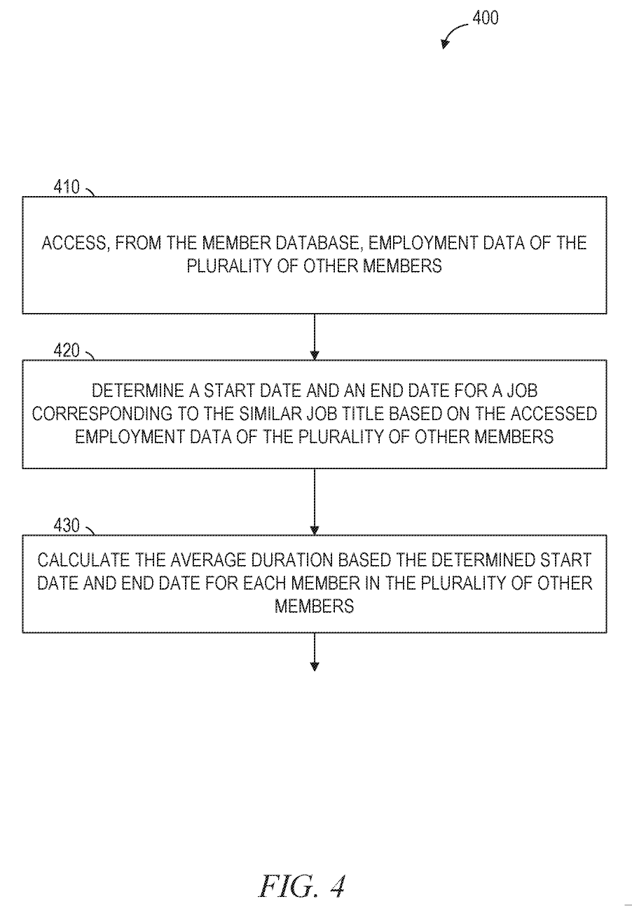

At operation 340, the job statistics calculator 206 determines, using a processor, an average duration for the first job title based on information accessed from the plurality of other members. For example, the job statistics calculator 206 can obtain the employment duration of the similar job title in order to determine the average duration for the first job title. A processor in the server machine 110 can perform the calculation in real-time. In some instances, part of the calculation at operation 340 can be performed offline using the offline data processor 220. FIG. 4 further describes techniques for calculating the average duration at operation 340.

As previously mentioned, the profile data 212 includes employment data of the members of the online social network 210. The employment data can include a start date and an end date. The average duration for each job title can be calculated based on the start date and the end date. In some instances, when the start date or end date is not available, the average duration is determined based on the number of new connections by the member. For example, the job statistics calculator 206 can infer that the member has switched to a new job based on the number of new connections at the new employer being above a threshold (e.g., above 10) for a predetermined period (e.g., one week).

At operation 350, the timeline generator 204 generates a first timeframe using the accessed employment data of the member. The first timeframe has a classification based on a comparison between the average duration and the specific duration. The average duration is calculated at operation 340, and the specific duration is accessed at operation 320.

In some instances, the first timeframe has a first classification when the specific duration is more than the average duration. Alternatively, the first timeframe has a second classification when the specific duration is less than the average duration. For example, the first classification can be a first color, and the second classification can be a second color.

For example, the first timeframe is color-coded based on the comparison. The first timeframe can be a first color when the average duration is less than the specific duration. Alternatively, the first timeframe can be a second color when the average duration is equal to or more than the specific duration. In some instances, the specific duration is calculated based on a start date and an end date associated with the first job title. A processor in the server machine 110 can generate the first timeframe in real-time. In some instances, the first timeframe is generated offline by the offline data processor.

At operation 360, the publisher 208 cause a presentation, on a display of the device (e.g., device 130), the profile page of the member having the generated first timeframe. As previously mentioned, the first timeframe is generated at operation 350. The publisher 208 can cause the presentation on the display of device 130 for user 132. In some instances, the publisher is a special-purpose graphical processing unit that generates the profile timeline.

In some instances, method 300 further includes the user interface 202 receiving a user input. The user input can be received from device 130 selecting the first timeframe. For example, the user input includes highlighting the first timeframe, hovering over the first timeframe with a mouse pointer, clicking on the first timeframe, and so on. In response to the received user input, the timeline generator 204 accesses, from a social graph database (e.g., social graph data 214), first-degree connections of the viewer that have the first employer listed as an employer. Subsequently, the publisher 208 presents one or more of the first-degree connections of the viewer that have the first employer listed an employer. For example, when the viewer selects the first timeline associated with a first job at a first employer, the publisher 208 can present all or some of the viewer's first-degree connections that also work or have worked at the first employer.

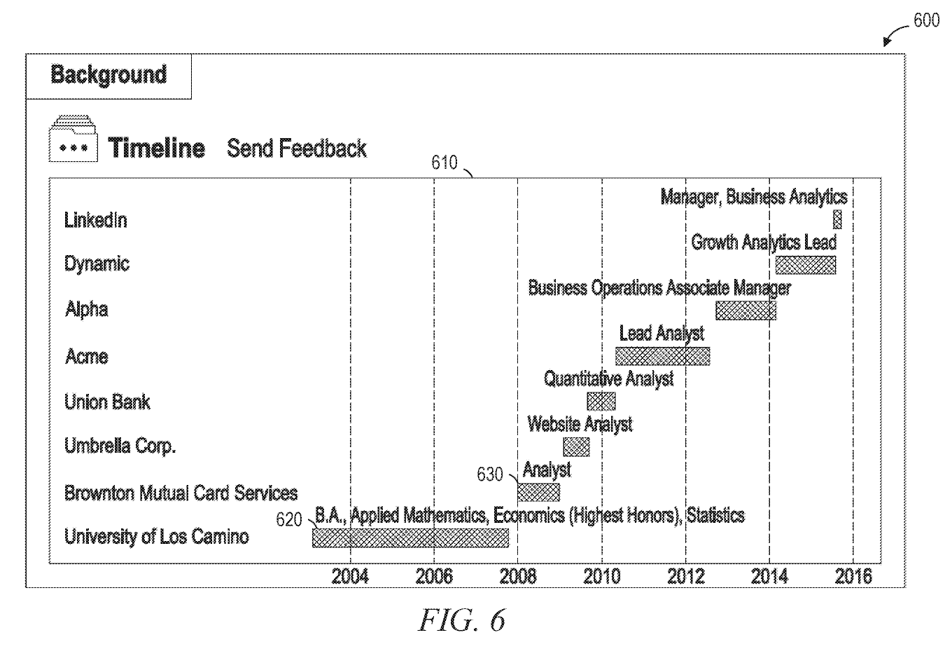

In some instances, method 300 further includes the profile generator 204 accessing, from an educational database in the online social network 210, educational data of the member. The profile data 212 can be educational information that is stored in the educational database. The educational data includes a degree associated with a major and a graduation duration (e.g., enrollment duration). As previously mentioned, the educational data can further include a minor concentration, a start date, an end date, an expected completion date, and so on. Additionally, the timeline generator 204 generates an educational timeframe using the accessed educational data. Subsequently, the publisher 208 publishes, on the profile page of the member, the generated educational timeframe. For example, the educational data can be accessed at operation 320, and the educational timeframe can be generated at operation 350. FIG. 6 illustrates a timeline having employment timeframes and educational timeframes, according to some embodiments.

Continuing with the profile having the educational timeframe example, the method 300 can further include determining a normal duration for the degree based on educational data of other members. Similar techniques to determine an average duration as later described in method 400 can also be performed to determine a normal duration. Subsequently, the timeline generator 204 can classify the educational timeline based on the duration to graduation and the normal duration. For example, the educational timeframe can be classified based on a comparison between the normal duration and the graduation duration at operation 330.

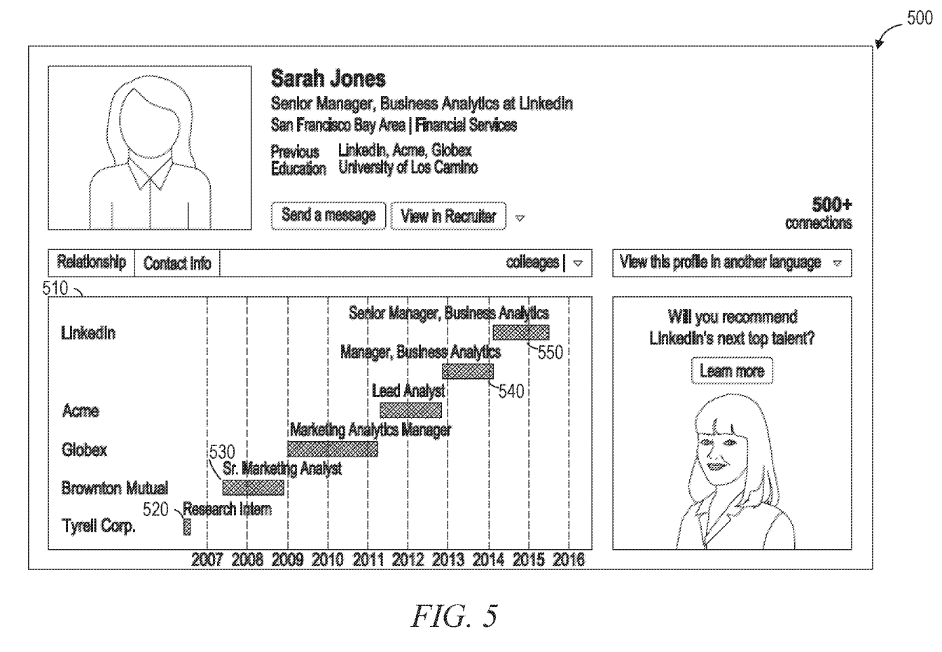

Additionally, the method 300 can further include the timeline generator 204 generating a second timeframe using the accessed employment data of the member. The second timeframe can be associated with a second job title at a second employer. Alternatively, the second timeframe can be a second job title at the first employer, or the second timeframe can be the first job title at a second employer. In some instances, the second timeframe can be an educational timeframe as previously described. FIG. 5 illustrates a profile timeline with a first timeframe and a second timeframe, according to some embodiments.

Furthermore, the profile generator 204 can classify the second timeframe based on another average duration associated with the second job title. The average duration associated with the second job title can be calculated based on method 400 of FIG. 4. Moreover, the publisher 208 can publish, on the profile page of the member, the second timeframe on the profile page of the member. The second timeframe and the first timeframe can be both included in the profile timeline and be published on the profile page at operation 360.

The system may further track or maintain a record of the employees that change employers. This feature is helpful because the viewer can view relevant information without having to such for it. Accordingly, in one embodiment, the second timeframe further includes a number of profiles of employees transferring from the first employer to the second employer over a predetermined time (e.g., last month, last three months, last six months, last year). For example, the profile timeline can highlight or emphasize when a threshold number (e.g., three, five) of employees have transitioned from the first employer to the second employer. The threshold number can be further based on the employer size.

In some instances, the first timeframe can include a number of employees that have recently left the first employer over a predetermined time (e.g., last month, last three months, last six months, last year). Additionally, the second timeframe can include a number of employees that have recently left the second employer. Furthermore, in addition to the number of employees that have recently left, the publisher 208 can present information from the profile pages of the employees that have recently left. For example, the profile timeline can present the profile pictures of first-degree connections of the viewer that has recently left the first or second employer.

In some instances, the first timeframe includes an average period of time that an employer works at the first employer. For example, inside of the first timeframe includes the number of years associated with the average period.

In some instances, the first timeframe includes a number of recommendations that the member received while working at the first employer. For example, the profile pictures of the recommending member is includes with the first timeframe. The profile pictures can be positioned above, below, or inside the first timeframe.

In some instances, the first timeframe includes a role description of the first job title. For example, the role description is accessed from the profile page or the company website. The role description can be presented when the viewer selects the first timeframe.

In some instances, the first timeframe includes a project description that the member worked on while at the first job title. For example, the project description is accessed from the profile page or the company website. The project description can be presented when the viewer selects the first timeframe.

In some instances, the first timeframe includes a number of employees that have transferred from the first employer in a predetermined period (e.g., three months, six months, one year). For example, inside of the first timeframe includes the number of employees that have recently transferred.

Furthermore, the second timeframe can have similar supplemental information (e.g., number of employees that have recently transferred) as the first timeframe as described above. In some instances, the first timeframe includes one type of supplemental information, while the second timeframe includes another type of supplement information.

FIG. 4 is a flowchart illustrating operations of the online social network 210 in performing a method 400 for determining the average duration for a job title, according to some example embodiments. As previously mentioned, the determining of the average duration is also performed at operation 340 of FIG. 3. Additionally, similar techniques as described in method 400 can be performed to determine the average duration (e.g., normal duration) for obtaining an educational degree from a specific school. Operations in the method 400 may be performed by the online social network 210, using the job statistics calculator 206 described above with respect to FIG. 2. As shown in FIG. 4, the method 400 includes operations 410, 420, and 430.

At operation 410, the job statistics calculator 206 accesses, from the member database, employment data of the plurality of other members. As previously mentioned, the member database stores the member data 218, which includes the profile data 212 (e.g., employment data, educational data). The employment data of each member is included in the profile data 212. Operation 330 of method 300 describes techniques for selecting the plurality of other members. For example, the plurality of other members are members that have the same job title in the same company, members that have the same job title in another company in the same industry, members that have a similar job title in the same company, or members that have a similar job title in another company in the same industry.

At operation 420, the job statistics calculator 206 determines a start date and an end date for a job corresponding to the similar job title based on the accessed employment data of the plurality of other members. In some instances, a profile page of a member from the plurality of other members actually includes a start date and an end date for a job title. In other instances, the start date and the end date are determined based on other information in the profile page, and information accessed from third-party websites. Information accessed from third-party websites includes notifications on social media sites of a start date for the job title or a subsequent job title. Additionally, third-party websites can include media outlets (e.g., newspapers) that announce new hires in the regions. Other information in the profile page may include a determination of a start date or end date based on a change of location or new connections to employees at the new employer.

In some instances, the start date or the end date can be determined based on connection data accessed from the social graph data 214. For example, when a member starts a new job, the member can add new first-degree connections at the new employer. Therefore, based on the number of new first-degree connections at a specific employer, the job statistics calculator 206 can determine a start date or an end date.

With regards to the calculation of the normal duration for obtaining a degree, the job statistics calculator 206 may determine a start date and an end date for a degree corresponding to the degree obtained by the member based on the accessed educational data of the plurality of other members.

At operation 430, the job statistics calculator 206 calculates the average duration based the determined start date and end date for each member in the plurality of other members. For example, the average duration can be calculated by summing the average duration for each member in the plurality of other members, and dividing the sum by the number of members in the plurality of other members. As later described, processors 710 can perform the calculations for operation 430 using specific instructions 716. The first timeline generated at operation 350 is generated based on the average duration calculated at operation 430.

FIG. 5 is a user interface diagram illustrating the profile timeline with a plurality of timeframes, according to some embodiments.

A user interface 500 in FIG. 5 presents a profile timeline 510 having a first timeframe 520, a second timeframe 530, a third timeframe 540, a fourth timeframe 550, and so on. The profile timeline 510 can be include in the profile page of the member, as illustrated in FIG. 5. The first timeframe 520 is associated with a first job at a first employer, and similarly the second timeframe 530 is associated with a second job at a second employer. Additionally, multiple timeframes for different job titles can be generated for the same employer, as illustrated by the third timeframe 540 and the fourth timeframe 550.

FIG. 6 is a user interface diagram illustrating the profile timeline with an educational timeframe and an employer timeframe, according to some embodiments.

A user interface 600 in FIG. 6 presents another example of a profile timeline 610 having a first timeframe 620 generated based on educational data, a second timeframe 630 generated based on employment data, and so on. The first timeframe 620 can also be referred to as an educational timeframe. The second timeframe 630 can also be referred to as an employment timeframe.

According to various example embodiments, one or more of the methodologies described herein facilitate a better user experience in the online social network 210. Additionally, based on the database structure illustrated in FIG. 2, the profile timeline is generated in real-time by using the offline data processor 220 for some calculations. For example, the online social network 210 can use the offline data processor 220, for the timeline generator 204 and the job statistics calculator, in such a way as to allow an efficient retrieval and processing of the information in order to generate the profile timeline in real-time.

When these effects are considered in aggregate, one or more of the methodologies described herein may obviate a need for certain human efforts or resources that otherwise would be involved in publishing a profile timeline. Furthermore, computing resources used by one or more machines, databases 115, or devices 130. 150 (e.g., within the network environment 100) may similarly be reduced (e.g., by pre-determining average duration). Examples of such computing resources include processor cycles, network traffic, memory usage, data storage capacity, power consumption, and cooling capacity.

### Example Machine Architecture and Machine-readable Medium

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 (e.g., timeline generator 204 FIG. 2) to execute the flow diagrams of FIGS. 3 and 4. Additionally, or alternatively, the instructions 716 may implement the job statistics calculator 206 of FIG. 2, and so forth. The instructions 716 transform the general, non-programmed machine 700 into a particular machine programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine 110 or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory/storage 730, and I/O components 750, which may be configured to communicate with each other such as via a bus 702. In an example embodiment, the processors 710 (e.g., a central processing unit (CPU), a reduced instruction set computing (RISC) processor, a complex instruction set computing (CNC) processor, a graphics processing unit (GPU), a digital signal processor (DSP), an application specific integrated circuit (ASIC), a radio-frequency integrated circuit (MC), another processor 710, or any suitable combination thereof) may include, for example, a processor 712 and a processor 714 that may execute the instructions 716. The term “processor” is intended to include multi-core processors 710 that may comprise two or more independent processors 712, 714 (sometimes referred to as “cores”) that may execute instructions 716 contemporaneously. Although FIG. 7 shows multiple processors 710, the machine 700 may include a single processor 712 with a single core, a single processor 712 with multiple cores (e.g., a multi-core processor), multiple processors 712, 714 with a single core, multiple processors 712, 714 with multiples cores, or any combination thereof.

The memory/storage 730 may include a memory 732, such as a main memory or other memory storage, and a storage unit 736, both accessible to the processors 710 such as via the bus 702. The storage unit 736 and memory 732 store the instructions 716 embodying any one or more of the methodologies or functions described herein. The instructions 716 may also reside, completely or partially, within the memory 732, within the storage unit 736, within at least one of the processors 710 (e.g., within the processor's cache memory), or any suitable combination thereof, during execution thereof by the machine 700. Accordingly, the memory 732, the storage unit 736, and the memory of processors 710 are examples of machine-readable media.

As used herein, “machine-readable medium” means a device 130, 150 able to store instructions 716 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)), and/or any suitable combination thereof. The term “machine-readable medium” should be taken to include a single medium or multiple media (e.g., a centralized or distributed database, or associated caches and servers) able to store the instructions 716. The term “machine-readable medium” shall also be taken to include any medium, or combination of multiple media, that is capable of storing instructions (e.g., instructions 716) for execution by a machine (e.g., machine 700), such that the instructions 716, when executed by one or more processors of the machine 700 (e.g., processors 710), cause the machine 700 to perform any one or more of the methodologies described herein. Accordingly, a “machine-readable medium” refers to a single storage apparatus or device 130, 150, as well as “cloud-based” storage systems or storage networks that include multiple storage apparatus or devices 130, 150. The term “machine-readable medium” excludes signals per se.

The I/O components 750 may include a wide variety of components to receive input, provide output, produce output, transmit information, exchange information, capture measurements, and so on. The specific I/O components 750 that are included in a particular machine 700 will depend on the type of machine 700. For example, portable machines such as mobile phones will likely include a touch input device or other such input mechanisms, while a headless server machine will likely not include such a touch input device. It will be appreciated that the I/O components 750 may include many other components that are not shown in FIG. 7. The 110 components 750 are grouped according to functionality merely for simplifying the following discussion and the grouping is in no way limiting. In various example embodiments, the I/O components 750 may include output components 752 and input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components); point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 750 may include biometric components 756, motion components 758, environmental components 760, or position components 762, among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 758 may include acceleration sensor components (e.g., accelerometer), gravitation sensor components, rotation sensor components gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/0 components 750 may include communication components 764 operable to couple the machine 700 to a network 780 or devices 770 via a coupling 782 and a coupling 772 respectively. For example, the communication components 764 may include a network interface component or other suitable device 130, 150 to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a Universal Serial Bus (USB)).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e,g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 780 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (IxRTT), Evolution-Data Optimized (EVDO) technology, General Packet Radio Service (CPRS) technology, Enhanced Data rates for GSM Evolution (EDGE) technology, third Generation Partnership Project (3GPP) including 3G. fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

The instructions 716 may be transmitted or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 716 may be transmitted or received using a transmission medium via the coupling 772 (e.g., a peer-to-peer coupling) to the devices 770. The term “transmission medium” shall be taken to include any intangible medium that is capable of storing, encoding, or carrying the instructions 716 for execution by the machine 700, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein., the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

Certain embodiments are described herein as including logic or a number of components, modules, or mechanisms. Modules may constitute software modules code stored or otherwise embodied on a machine-readable medium or in a transmission medium), hardware modules, or any suitable combination thereof. A “hardware module” is a tangible (e.g., non-transitory) unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor 710 or a group of processors 710) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor 710 or other programmable processor 710. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, and such a tangible entity may be physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor 710 configured by software to become a special-purpose processor, the general-purpose processor 710 may be configured as respectively different special-purpose processors (e.g., comprising different hardware modules) at different times. Software (e.g., a software module) may accordingly configure one or more processors 710, for example, to constitute a particular hardware module at one instance of time and to constitute a different hardware module at a different instance of time,

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors 710 that are temporarily configured (e.g., by software) or permanently configured to perform the relevant operations. Whether temporarily or permanently configured, such processors 710 may constitute processor-implemented modules that operate to perform one or more operations or functions described herein. As used herein, “processor-implemented module” refers to a hardware module implemented using one or more processors 710.

Similarly, the methods described herein may be at least partially processor-implemented, a processor 710 being an example of hardware. For example, at least some of the operations of a method may be performed by one or more processors 710 or processor-implemented modules. As used herein, “processor-implemented module” refers to a hardware module in which the hardware includes one or more processors 710. Moreover, the one or more processors 710 may also operate to support performance of the relevant operations in a “cloud computing” environment or as a “software as a service” (SaaS). For example, at least some of the operations may be performed by a group of computers (as examples of machines 700 including processors 710), with these operations being accessible via a network 780 (e.g., the Internet) and via one or more appropriate interfaces (e.g., an application programming interface (API)).

The performance of certain operations may be distributed among the one or more processors 710, not only residing within a single machine 700, but deployed across a number of machines 700. In some example embodiments, the one or more processors 710 or processor-implemented modules may be located in a single geographic location (e.g., within a home environment, an office environment, or a server farm). In other example embodiments, the one or more processors 710 or processor-implemented modules may be distributed across a number of geographic locations.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine 700. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine 700 (e.g., a computer) that manipulates or transforms data represented as physical (e.g., electronic, magnetic, or optical) quantities within one or more memories 732 (e.g., volatile memory, non-volatile memory, or any suitable combination thereof), registers, or other machine components that receive, store, transmit, or display information. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A method comprising:
receiving, from a device of a viewer, a request to view a profile page of a member of an online social network;
accessing, from a member database in the online social network, employment data of the member, the employment data having a first job associated with a first job title at a first employer with a specific duration;
selecting a plurality of other members, each member in the plurality of other members having a similar job title, the similar job title being related to the first job title;
determining, using a processor, an average duration for the first job title based on information accessed from the plurality of other members;
generating a first timeframe using the accessed employment data of the member, the first timeframe having a classification based on a comparison between the average duration and the specific duration; and
causing a presentation, on a display of the device, of the profile page of the member having the generated first timeframe.

2. The method of claim 1, further comprising:
receiving a user input selecting the first timeframe;
accessing, from a social graph database, first-degree connections of the viewer that have the first employer listed as an employer; and
presenting, in response to the user input, one or more of the first-degree connections of the viewer that have the first employer listed as the employer.

3. The method of claim 1, further comprising:
accessing, from an educational database in the online social network, educational data of the member, the educational data having a degree associated with a major and a graduation duration;
generating an educational timeframe using the accessed educational data; and
publishing, on the profile page of the member, the generated educational timeframe.

4. The method of claim 3, further comprising:
determining a normal duration for the degree based on educational data of other members; and
classifying the educational timeframe based on the graduation duration and the normal duration.

5. The method of claim 1, further comprising:
generating a second timeframe using the accessed employment data of the member, the second timeframe being associated with a second job title at a second employer;
classifying the second timeframe based on another average duration associated with the second job title; and
publishing, on the profile page of the member, the second timeframe.

6. The method of claim 5, wherein the second timeframe includes a number of employees transferring from the first employer to the second employer over a predetermined period.

7. The method of claim 1, wherein the determining the average duration includes:
accessing, from the member database, employment data of the plurality of other members;
determining a start date and an end date for a job corresponding to the similar job title based on the accessed employment data of the plurality of other members; and
calculating the average duration based on the determined start date and end date for each member in the plurality of other members.

8. The method of claim 1, wherein the specific duration is determined from a start date and an end date of the first job, the start date and the end date being listed on the profile page of the member.

9. The method of claim 1, wherein the timeframe has a first classification when the specific duration is more than the average duration.

10. The method of claim 9, wherein the timeframe has a second classification when the specific duration is less than the average duration.

11. The method of claim 10, where the first classification is a first color, and wherein the second classification is a second color.

12. The method of claim 1, further comprising:
accessing, from a standardized jobs database, a list of job titles that correspond to the first job title, wherein the similar job title is related to the first job title when the similar job title is included in the list of job titles.

13. The method of claim 1, wherein the similar job title matches the first job title.

14. The method of claim 1, wherein the first timeframe includes an average period of time that the member works at the first employer.

15. The method of claim 1, wherein the first timeframe includes a number of recommendations that the member received while working at the first employer.

16. The method of claim 1, wherein the first timeframe includes a role description of the first job title.

17. The method of claim 1; wherein the first timeframe includes a project description that the member worked on while at the first job title.

18. The method of claim 1, wherein the first timeframe includes a number of employees that have transferred from the first employer in a predetermined time.

19. A non-transitory machine-readable storage medium comprising instructions that; when executed by one or more processors of a machine, cause the machine to perform operations comprising:
receiving, from a device of a viewer, a request to view a profile page of a member of an online social network;
accessing, from a member database in the online social network, employment data of the member; the employment data having a first job associated with a first job title at a first employer with a specific duration;
selecting a plurality of other members; each member in the plurality of other members having a similar job title, the similar job title being related to the first job title;
determining an average duration for the first job title based on information accessed from the plurality of other members;
generating a first timeframe using the accessed employment data of the member, the first timeframe having a classification based on a comparison between the average duration and the specific duration; and
causing a presentation, on a display of the device, of the profile page of the member having the generated first timeframe.

20. An online social network comprising:
a database having member data of members, the member data including employment data of a member in the online social network; and
one or more processors in a publisher to:
receive, from a device of a viewer, a request to view a profile page of the member of the online social network;
access, from the database, the employment data of the member, the employment data having a first job associated with a first job title at a first employer with a specific duration;
select a plurality of other members, each member in the plurality of other members having a similar job title; the similar job title being related to the first job title;
determine an average duration for the first job title based on information accessed from the plurality of other members;
generate a first timeframe using the accessed employment data of the member, the first timeframe having a classification based on a comparison between the average duration and the specific duration; and
cause a presentation, on a display of the device, of the profile page of the member having the generated first timeframe.
